(19) United States
(12) Patent Application Publication
(10) Pub. No.: US 2026/0241906 A1
(43) Pub. Date: Aug. 20, 2026

(54) ELECTRICALLY CONTROLLABLE SOLENOID VALVE

(71) Applicant: Robert Bosch GmbH, Stuttgart (DE)

(72) Inventors: Marcus Ertle, Immenstadt (DE); Andreas Weh, Sulzberg (DE); Florian Rispler, Hirschegg (AT)

(21) Appl. No.: 19/475,327

(22) PCT Filed: Jun. 21, 2024
(86) PCT No.: PCT/EP2024/067374

§ 371 Date: Oct. 14, 2025

(30) Foreign Application Priority Data
Sep. 1, 2023 (DE) 10 2023 208 422.8

(51) Int. Cl. B60T 8/36

(52) U.S. Cl. CPC B60T 8/363

(57) ABSTRACT

An electrically controllable solenoid valve, in particular for open-loop and/or closed-loop control of a pressure medium connection in a hydraulic unit of an electronically slip-controllable vehicle brake system. Some solenoid valves have a valve insert including a lower part with a control cross-section and an upper part for guiding a tappet. A closing element is coupled to the tappet for controlling the control cross-section. To actuate the valve, a magnetic coil acts on a magnetic armature, which actuates the tappet against the force of a return element. The lower part has an end portion which is inserted into a lower part receptacle in the upper part. The end portion includes at least one recess which is open toward the upper part and penetrates a wall of the lower part in radial direction.

### FIELD

The present invention is part of the technical field of electronically slip-controllable vehicle brake systems and relates to an electrically controllable solenoid valve, which is used in such vehicle brake systems to release or block a pressure medium connection within a hydraulic unit.

A plurality of such solenoid valves are disposed on a housing block of this hydraulic unit together with a likewise electrically controllable motor of a brake pressure generator, and are supplied with electrical power as needed by an electronic control unit depending on acquired sensor signals.

The solenoid valve according to the present invention is preferably provided for controlling a pressure medium connection between a master brake cylinder and the wheel brakes of a brake circuit of the vehicle brake system. In normal operation, the solenoid valve interrupts this pressure medium connection and thus decouples the driver from the wheel brakes. During fault operation, the solenoid valve releases this pressure medium connection so that the driver can build up brake pressure in the wheel brakes using muscle power and the vehicle can be braked despite the electrical malfunction.

### BACKGROUND INFORMATION

Certain electrically controllable solenoid valves are described in the related art. As an example, reference is made in this context to Germany Patent Application No. DE 10 2018 219 955 A1.

For reasons of cost, the valve housing or the valve insert in the solenoid valve described here is made of multiple parts and accordingly comprises an upper part and a lower part. The two housing parts are both hollow-cylindrical and overlap one another in sections along their length with extensions that face one another. A first extension is formed on the upper part and engages in a receptacle on a second extension of the lower part. A tappet which holds a closing body of the solenoid valve at its end is guided in a displaceable manner in the upper part. A control cross-section of the solenoid valve which is controlled by this closing element is disposed on the lower part.

To implement a pressure medium connection between a first pressure medium port disposed on the end face of a valve insert facing away from the armature and a second pressure medium port disposed on the perimeter of the valve insert, groove-shaped formations are provided on the upper part downstream of the control cross-section. These groove-shaped formations are divided into an axial groove section in the region of the axial overlap or an existing press connection between the upper part and the lower part, and a radial groove section into which the aforementioned axial groove section opens with one of its ends. Viewed in longitudinal direction of the solenoid valve, the radial groove section is disposed above the region in which the upper part and the lower part overlap and therefore precludes any possible reduction in the axial overall length of this solenoid valve.

The reason for this is that deeper insertion of the radial groove section into the upper part would weaken the cross-section of the valve insert in a region in which a valve flange of the solenoid valve is formed and in which the solenoid valve is caulked to the housing block. This makes it more difficult to absorb any radial caulking forces that occur or dissipate them to the housing block.

The change in the cross-section of the valve insert caused by more deeply inserted radial groove sections would also affect the magnetic transition between the upper part and the lower part and can lead to a reduction of the magnetic force provided by the magnetic circuit.

Lastly, more deeply inserted radial groove sections on the upper part would result in strong flow deflection within a valve chamber, which increases the flow resistance of the solenoid valve.

An object of the present invention is therefore to provide a solenoid valve that avoids or improves these discussed disadvantages.

### SUMMARY

In a solenoid valve according to an example embodiment of the present invention, the lower part is connected to the upper part by means of an end portion that can be inserted into an associated lower part receptacle on the upper part. This end portion comprises at least one recess which is open toward the upper part and penetrates a wall of the lower part in radial direction. The recess is part of a pressure medium connection between the first and the second pressure medium port of the solenoid valve and provides the following advantages:
Because the recess is disposed on the lower part, this recess is on the same level as the region of the valve insert where the upper part and lower part are joined together. This makes it possible to reduce the axial overall length of the solenoid valve, in particular below a caulking flange. The first and the second pressure medium port of the solenoid valve also move closer together axially and the pressure medium less far to go when it flows through the valve chamber of the solenoid valve. Together with a less pronounced deflection of the pressure medium flow, this results in a lower flow resistance of a solenoid valve according to the present invention.
The cross-section of the upper part in the region of its caulking flange does not need any pressure medium-carrying channels and is therefore dimensionally stable. To anchor the solenoid valve to the housing block, high caulking forces can be applied, or any caulking forces that occur can be dissipated more easily to the housing block via the valve insert.
The influence of the pressure medium-carrying channels on the magnetic circuit is reduced because the common contact surface between the upper part and the lower part is larger.

Further advantages or advantageous further developments of the present invention will emerge from the disclosure herein.

### BRIEF DESCRIPTION OF THE DRAWINGS

An embodiment example of the present invention is shown in the figures and explained in detail in the following description.

Two figures are provided, in which corresponding features are provided with the same reference numbers.

FIG. 1 shows a longitudinal section of a valve assembly configured according to an example embodiment of the present invention of an electrically controllable solenoid valve. This valve assembly is accommodated in a valve receptacle of a housing block, of which FIG. 1 shows the area surrounding this valve receptacle.

FIG. 2 shows a perspective view of the lower part of a solenoid valve according to the present invention as a single part looking toward the end face of this lower part facing the upper part.

### DETAILED DESCRIPTION OF EXAMPLE EMBODIMENTS

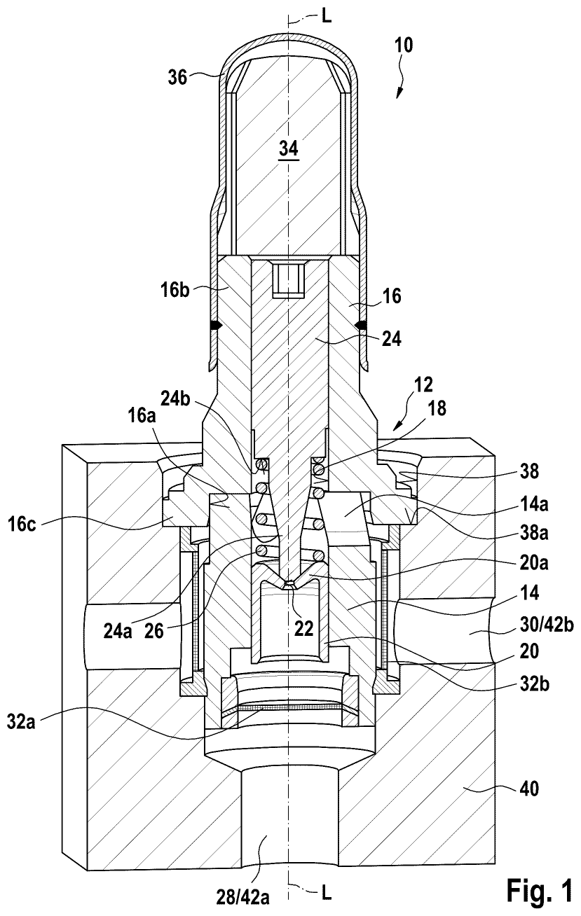

For the sake of simplicity, the valve assembly (10) shown in FIG. 1 is depicted without the mounted magnetic coil. It can be assumed that this valve assembly (10) can be fitted with a not depicted annular magnetic coil that encloses a so-called valve dome which projects beyond an outer side of a housing block (40). The valve assembly (10) and the magnetic coil together form the solenoid valve underlying the present invention.

The shown valve assembly (10) comprises a valve housing or a valve insert (12), which is made of multiple parts and consists of a lower part (14) and an upper part (16). The upper part and the lower part are both hollow cylindrical or sleeve-shaped and are coaxially inserted into one another. According to the present invention, the lower part (14) comprises an end portion (14a) with which it is pressed into a lower part receptacle (16a) formed on the upper part (16) in order to thus create a force/form-locking connection between the upper part (16) and the lower part (14). When joined together, the upper part (16) and the lower part (14) enclose a continuous cylindrical valve chamber (18) with an inner diameter that remains constant axially over a long distance and widens at the front-side open end of the lower part (14), for example into two right-angled steps. A cup-shaped valve body (20) is accommodated in the valve chamber (18) and is inserted with its base (20a) facing forward into the open end of the lower part (14) and firmly anchored in the smallest diameter region of this valve chamber (20), for example, by means of a press connection. A through-opening, which determines a control cross-section (22) of the solenoid valve, is formed in the center of the base of the valve body (20). Provided to control it is a pin-shaped closing element (24a) that is formed at one end of a tappet (24) facing the lower part (14). The tappet (24) is in turn guided with its peripheral wall in an axially displaceable manner in the upper part (16) of the valve insert (12).

A peripheral annular shoulder (24b) forms a transition from the closing element (24a) to the tappet (24) and serves as a support for a first of the two ends of a return element (26) of the valve assembly (10) which is in the form of a spiral spring. With its opposite second end, the spiral spring rests against the base (20a) of the valve body (20). The return element (26) or the spiral spring is centered on the closing element (24a) and surrounds the control cross-section (22) of the valve assembly (10) formed on the valve body (20). The purpose of the return element (26) is to lift the closing element (24a) away from the control cross-section (22) when the solenoid valve is not electrically actuated and thus open the control cross-section (22) to allow a pressure medium to flow through the valve chamber (18) or the control cross-section (22). The pressure medium then flows around the return element (26).

The pressure medium enters the valve chamber (18) at a first pressure medium port (28) and exits this valve chamber (18) again via a second pressure medium port (30). The pressure medium ports in this invention are both disposed on the lower part (14) of the valve insert (12), wherein the first pressure medium port (28) is located on the front-side open end of the lower part, while the second pressure medium port is disposed on the perimeter of the end of the lower part (14) close to the upper part (16). The pressure medium ports (28; 30) are assigned pressure medium channels (42a; 42b) of the housing block (40).

To prevent contaminants contained in the pressure medium from entering the valve chamber (18) or being flushed out of the valve chamber (18) into the downstream pressure medium circuit, filter elements (32a, b) are assigned to the pressure medium ports (28; 30). A first filter element (32a) is configured as a flat filter, which is pressed with its filter body into one of the steps of the diameter at the front end of the valve insert (12). In contrast, the second filter element is sleeve-shaped and pushed onto the outside of the lower part (14) of the valve insert (12) with radial pretension.

To actuate the tappet (24), a magnetic armature (34) is provided, which is placed on the outer side of the valve insert (12) facing the upper part (16) and rests there with its armature end surface on an end face of the tappet (24) facing away from the closing element. The magnetic armature (34) is disposed in an axially movable manner in the interior of a valve capsule (36) that is closed on one side in a dome shape and with its open end is fastened to the outer perimeter of the upper part (16) of the valve insert (12), in this embodiment example by means of a circumferential weld connection, for instance.

The upper part (16) of the valve insert (12) has a multiply stepped outer contour and is divided into a cylindrical shaft (16b) to which the valve capsule (36) is fastened, an axially adjoining transition section to larger outer dimensions of the valve insert (12) and, at its end facing the lower part (14), a peripheral caulking flange (16c). This caulking flange (16c) is at the same height as the lower part receptacle (16a) formed on the upper part (16a), as a result of which a largely constant wall cross-section of the upper part (16) is realized.

The caulking flange (16c) also projects radially outward from the valve insert (12) in order to anchor the valve assembly (10) in an associated valve receptacle (38) on a housing block (40) of a hydraulic unit. For this purpose, the valve assembly (10) is inserted into the valve receptacle (38) from the outside until the caulking flange (16c) rests peripherally against a shoulder (38a) formed by the valve receptacle (38). Material from the area surrounding the valve receptacle (38) of the housing block (40) is then deformed into the interior of this valve receptacle (38) by means of a stamping or caulking process in such a way that the deformed material covers the caulking flange (16c) of the valve body (20) at least in segments and thus secures the valve assembly on the housing block (40). Selecting the position of the shoulder (38a) within the valve receptacle (38) ensures that the pressure medium ports of the solenoid valve are in contact with associated pressure medium channels (42a; 42b) on the housing block (40) and are hydraulically sealed against one another.

Electrically controlling the not depicted magnetic coil creates a magnetic field, as a result of which a first magnetic pole forms on the end face of the magnetic armature (34) facing the tappet (24) and a second magnetic pole forms on the end face of the upper part (16) of the valve insert (12) facing the magnetic armature (34). The magnetic attraction force acting between the magnetic poles causes an actuation of the tappet (24) against the force of the return element (26). The magnetic armature (34) approaches the valve insert (12) until there is only a small air gap between the facing end faces, and the closing element (24a) connected to the tappet (24a) moves successively closer to the control cross-section (22) until it finally rests on this control cross-section (22) and interrupts the connection between the pressure medium channels (42a; 42b).

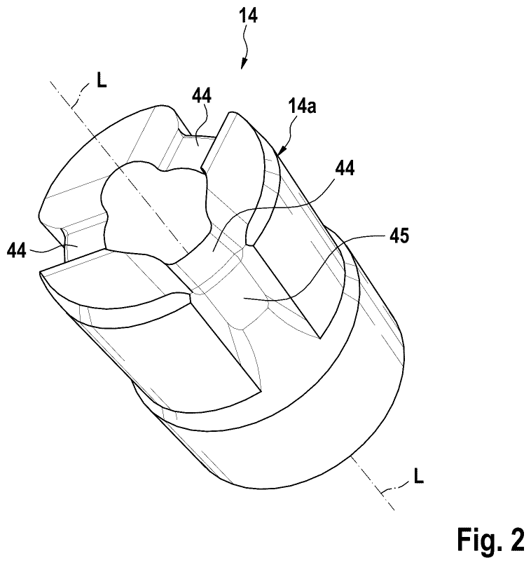

FIG. 2 shows the lower part (14) of the valve insert (12) as a single part in a perspective view. It can be seen that this lower part (14) is configured as a sleeve-shaped formed part, in particular a cold-formed part, that comprises recesses (44) on its end portion (14a) pressed into the upper part (16). In the shown embodiment example, three such recesses (44) are disposed distributed at equal angular distances across the end face, for instance, wherein the number, arrangement or dimensions of the recesses (44) are not crucial to the present invention or can be freely selected depending on the application.

These recesses (44) have an open end which faces the upper part (16) and penetrate the wall of the lower part (14) in radial direction. On the outer perimeter of the lower part (14), the recesses (44) respectively transition into a longitudinal groove (45) which extends in the direction of the longitudinal axis L and terminates approximately in the middle of the lower part (14) at a conical peripheral transition section. At the transition section, the dimensions of the lower part increase to an outer diameter that is somewhat larger than the outer diameter of the lower part (14) in the region of the recesses (44) or longitudinal grooves (45). Adjoining the transition section is a cylindrical section which extends to the front-side end of the lower part (14).

The recesses (44), which are open to the top, together with the longitudinal grooves (45), which are open to the outside, at the perimeter of the lower part (14) form pressure medium-carrying channels through which the pressure medium flows out of the valve chamber (18). Since these channels are open to the outside, they can be produced on the sleeve-shaped lower part (14) by forming, for example by cold-forming.

According to the present invention, the caulking flange (16c) and the end region (14a) in which the lower part (14) and the upper part (16) of the valve insert (12) are joined together are located on at least approximately the same plane when the solenoid valve is assembled. On the one hand, this results in a reliable fastening of the individual parts of the valve insert (12) to one another and, on the other hand, in a rigid fastening of the valve assembly (10) to the housing block (40) of a hydraulic unit. The recesses (44) and the longitudinal grooves (45), i.e. the pressure medium-carrying channels, are furthermore configured only on the lower part (14), which enables a valve assembly (10) with a particularly short axial overall length. In the solenoid valve according to the present invention, the pressure medium ports (28; 30) are positioned axially close to one another, which results in a short flow path along which the pressure medium flows through the solenoid valve or the valve assembly (10). This flow path is also free of significant flow deflections, so that the solenoid valve or the valve assembly (10) of the solenoid valve exhibits a low flow resistance. The individual parts of the valve insert (12) can be produced by forming and can thus be produced cost-efficiently.

The upper part (16) of the valve assembly (10) does not need any pressure medium-carrying channels and, due to its stability, can therefore easily dissipate any radial caulking forces that occur to the housing block (40).

Of course, modifications or advantageous further developments of the discussed embodiment example which do not depart from the scope of protection of the present invention are possible.

1-10. (canceled)

11. An electrically controllable solenoid valve for open-loop and/or closed-loop control of a pressure medium connection in a hydraulic unit of an electronically slip-controllable vehicle brake system, the solenoid valve comprising:
a valve insert which includes a lower part with a control cross-section, and an upper part connected to the lower part or guiding a tappet;
a closing element which is coupled to the tappet for controlling the control cross-section; and
an actuatable magnetic armature which acts on the tappet against the force of a return element;
wherein the lower part can be inserted with an end portion into an associated lower part receptacle of the upper part, and
wherein the end portion includes at least one recess which is open toward the upper part and penetrates a wall of the lower part in radial direction.

12. The solenoid valve according to claim 11, wherein the recess opens into a longitudinal channel formed on an outer perimeter of the lower part.

13. The solenoid valve according to claim 11, wherein, viewed in a direction of a longitudinal axis of the valve insert, the lower part receptacle of the upper part is disposed at a same height as a caulking flange.

14. The solenoid valve according to claim 11, wherein the lower part and the upper part are produced by cold-forming.

15. The solenoid valve according to claim 11, wherein the lower part and the upper part are connected to one another in a form and/or force-locking manner, by being pressed into one another.

16. The solenoid valve according to claim 11, wherein a valve body, on which the control cross-section of the solenoid valve is formed and on which the return element is axially supported with a first of its ends, is inserted into the lower part.

17. The solenoid valve according to claim 11, wherein the tappet includes an annular shoulder on which the return element is supported with a second of its ends.

18. The solenoid valve according to claim 16, wherein the return element is disposed between the tappet and the valve body in a section of a valve chamber through which the pressure medium flows.

19. The solenoid valve according to claim 16, wherein, at its end facing away from the upper part, the lower part has an inner diameter that is stepped from an outside to an inside, and wherein a filter element is disposed in an axially fixed manner in one step of the diameter.

20. The solenoid valve according to claim 19, wherein the valve body and the filter element are each fastened in a force and/or form-locking manner in an interior of the lower part.
